(19) United States
(12) Patent Application Publication
(10) Pub. No.: US 2023/0005087 A1
(43) Pub. Date: Jan. 5, 2023

(54) MAPPING SYSTEM

(71) Applicant: GLOBAL THEMATIC INSIGHTS LLC, Austin, TX (US)

(72) Inventors: Scott W. Imbus, Katy, TX (US); Frederic I. Frasse, Houston, TX (US)

(21) Appl. No.: 17/776,984

(22) PCT Filed: Nov. 13, 2020
(86) PCT No.: PCT/US2020/060521

§ 371 Date: May 13, 2022

Related U.S. Application Data
(60) Provisional application No. 62/936,044, filed on Nov. 15, 2019.

(51) Int. Cl. G06Q 50/14; G06Q 10/02; G06Q 30/06

(52) U.S. Cl. CPC G06Q 50/14; G06Q 10/025; G06Q 30/0631

(57) ABSTRACT

A mapping system that stores user profile data and geographic information system (GIS) data. The mapping system identifies topics of interest to the user, identifies component maps that are relevant to the topics of interest, and generates composite maps of geographic locations having unique combinations of attributes relevant to the topics of interest. The boundaries of the geographic locations may be adjusted to conform to subnational boundaries. The composite maps provide functionality for users to identify locations of interest. The mapping system may receive third-party geographic data and organize it into a hierarchical taxonomy. The mapping system may then provide a graphical user interface to identify items of interest to the user, for example in locations of interest to the user. The third-party geographic data may further include transportation and accommodations information and the mapping system may generate an itinerary for travelling to the locations or items of interest.

### CROSS-REFERENCE TO RELATED APPLICATIONS

This application claims priority to U.S. Prov. Pat. Appl. No. 62/936,044, filed Nov. 15, 2019, which is hereby incorporated by reference.

### FEDERAL FUNDING

None

### BACKGROUND

Geographic information systems (GIS), which analyze and display geographically referenced information, provide powerful tools for users with access to GIS map data and the skills to use those GIS programs. Meanwhile, the Internet is replete with sources of information relevant to specific geographic locations, from websites for travelers to online encyclopedias.

Individuals interested in travel, educational organizations, and organizations performing business intelligence functions would benefit from a software program with GIS functionality as well as information from online sources that is relevant to specific geographic locations. However, most users do not have access to GIS data, let alone multiple GIS data sets regarding multiple topics that may be of interest to the user. Furthermore, finding information regarding location-specific topics requires independent research from a multitude of sources on the Internet.

Therefore, there is a need for a graphical user interface that provides functionality for users to view GIS data regarding topics of interest and identify locations of interest. Furthermore, there is a need for a graphical user interface that organizes and presents the disparate information available via the Internet regarding those topics and locations of interest and provides functionality for users to identify and learn about objects of interest in those locations. Finally, having identified locations and objects of interest, there is a need for a graphical user interface that identifies transportation and accommodation to travel to those locations and objects of interest, preferably within the user's time frame and budget (and, ideally, optimized to minimize travel time, avoid times when attractions are closed or crowded, etc.).

### SUMMARY

In order to overcome those and other disadvantages in the prior art, a mapping system that stores user profile data and geographic information system (GIS) map data is provided. The mapping system identifies topics of interest to the user, identifies component maps in the GIS map data that are relevant to the topics of interest, and generates composite maps of geographic locations having unique combinations of attributes relevant to the topics of interest. The boundaries of the geographic locations may be adjusted to conform to subnational boundaries. The composite maps provide functionality for users to identify locations of interest.

The mapping system may also receive third-party geographic data regarding each location of interest to the user. The third-party geographic data may be organized into a hierarchical taxonomy. The mapping system may then provide a graphical user interface that displays the third-party geographic data regarding topics of interest to the user and locations of interest to the user. The graphical user interface may provide functionality for the user to identify items of interest to the user.

The third-party geographic data may further include transportation and accommodations information. Accordingly, the mapping system may generate an itinerary for the user to travel to the locations of interest to the user and/or the items of interest to the user.

### BRIEF DESCRIPTION OF THE DRAWINGS

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure.

FIG. 1 is a functional block diagram illustrating a mapping environment according to an embodiment of the present invention.

FIG. 2 is a block diagram of a mapping system 200 according to an exemplary embodiment.

FIG. 3 illustrates component maps 250 according to an exemplary embodiment.

FIG. 4 illustrates an example composite map 260a according to an exemplary embodiment.

FIG. 5 illustrates another example composite map 260b according to an exemplary embodiment.

FIG. 6 illustrates another example composite map 260c according to an exemplary embodiment.

FIG. 7 illustrates a thematic thread output via a graphical user interface according to an exemplary embodiment.

FIG. 8 illustrates a thematic thread output via the graphical user interface according to another exemplary embodiment.

FIG. 9 illustrates a thematic thread output via the graphical user interface according to another exemplary embodiment.

FIG. 10 illustrates an itinerary view output by the graphical user interface according to an exemplary embodiment.

FIG. 11 is a flowchart of a process for generating the component maps, the composite maps, the thematic threads, and/or the itinerary views according to an exemplary embodiment.

FIG. 12 is a block diagram of a computing system within the mapping environment of FIG. 1 according to an exemplary embodiment.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

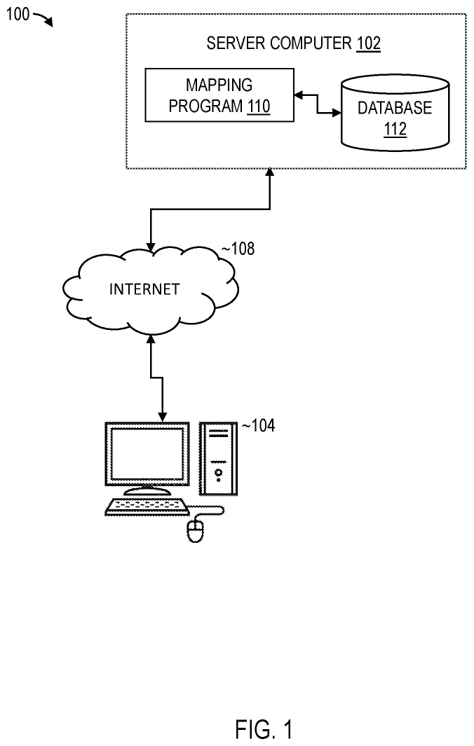

FIG. 1 is a functional block diagram illustrating a mapping environment 100 according to an embodiment of the present invention. FIG. 1 provides only an illustration of one implementation and does not imply any limitations with regard to the environments in which different embodiments may be implemented. Many modifications to the depicted environment (including external data import and rendering) may be made by those skilled in the art without departing from the scope of the invention as recited by the claims.

As shown in FIG. 1, the mapping environment 100 includes server computer 102 and user device 104, all interconnected over one or more networks 108.

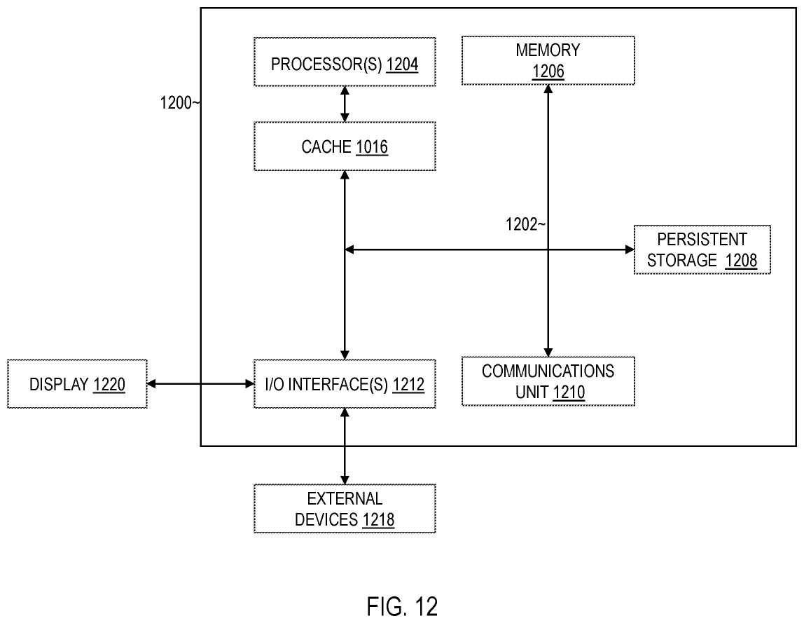

The server computer 102 and user device 104 may be a standalone computing device, a management server, a webserver, a mobile computing device, or any other electronic device or computing system capable of receiving, sending, and processing data. In other embodiments, server computer 102 and user device 104 may represent a server computing system utilizing multiple computers as a server system, such as in a cloud computing environment. In another embodiment, the server computer 102 and the user device 104 may be a laptop computer, a tablet computer, a netbook computer, a personal computer (PC), a desktop computer, a personal digital assistant (PDA), a smart phone, or any programmable electronic device capable of communicating with various components and other computing devices (not shown) within mapping environment 100. In another embodiment, server computer 102 and user device 104 may each represent a computing system utilizing clustered computers and components (e.g., database server computers, application server computers, etc.) that act as a single pool of seamless resources when accessed within mapping environment 100. The server computer 102 and user device 104 may include internal and external hardware components capable of executing machine-readable program instructions, as depicted and described in further detail with respect to FIG. 12. In other embodiments, server computer 102 and user device 104 may be a single device.

The server computer 102 includes map program 110 and database 112. The database 112 may be any repository of data accessible by the map program 110. In some embodiments, the map program 110 may be realized by software instructions stored and executed by the server computer 102 (e.g., a web application) and available to the user device 104 (e.g., via a web browser). In other embodiments, the map program 110 may be realized as software instructions to and stored and executed by the user device 104 (e.g., a software application or mobile application) downloaded in communication with the server computer 102 (e.g., via an application server or mobile application server). The database 112 may be implemented with any type of storage device capable of storing data and configuration files that can be accessed and utilized by server computer 102, such as a database server, a hard disk drive, or a flash memory. In most instances, the map program 110 uses data stored in the remote database 112. However, in some instances, data may be stored locally by the user device 104, for example to provide functionality when the server computer 102 or the network(s) 108 are unavailable.

The network(s) 108 may include, for example, any telecommunications network, local area network (LAN), wide area network (WAN) such as the Internet. The network(s) 108 may include wired, wireless, and/or fiber optic connections. The network(s) 108 may include one or more wired and/or wireless networks that are capable of receiving and transmitting data, voice, and/or video signals, including multimedia signals that include voice, data, and video information. In general, the networks 108 may include any combination of connections and protocols that will support communications among the server computer 102, the user device 104, and other computing devices (not shown) within mapping environment 100.

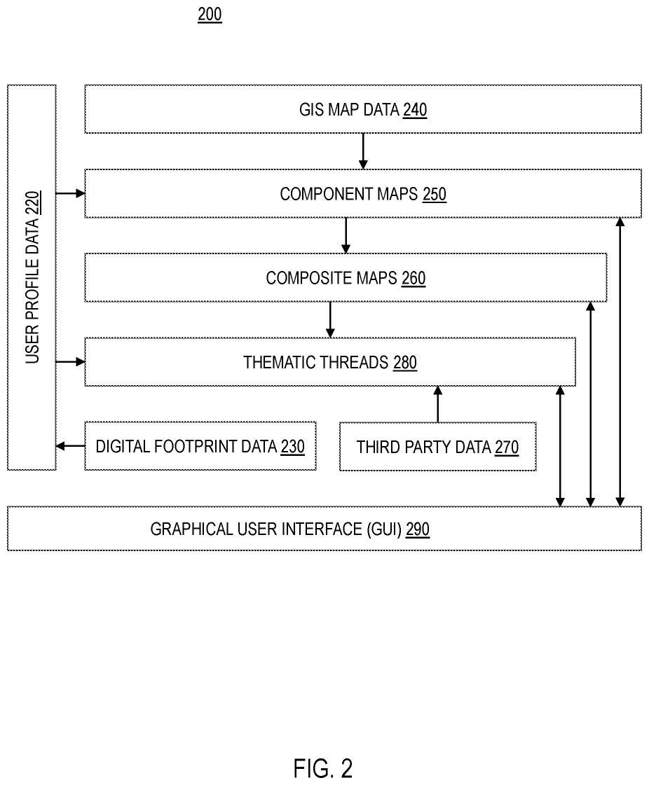

FIG. 2 is a block diagram of a mapping system 200 according to an exemplary embodiment.

As shown in FIG. 2, the mapping system includes user profile data 220, geographic information system (GIS) map data 240, and a graphical user interface (GUI) 290. The mapping system 200 may also include digital footprint data 230 and third-party geographic data 270. As described in detail below, the mapping program 110 uses the user profile data 220 and the GIS map data 240 to generate component maps 250 and composite maps 260 of interest to the user. Also, the mapping program 110 uses the user profile data 220, the composite maps 260, and the third-party geographic data 270 to generate thematic threads 280, which are visual depictions of information relevant to the locations of interest to the user.

The user profile data 220 may include any information used by the mapping program 110 to identify topics of interest to the user. The user profile data 220 may be stored by the server computer 102 in any non-transitory computer-readable storage medium (for example, the database 112).

The user profile data 220 may include information input by the user (via the graphical user interface 290) and information determined by the mapping program 110 (e.g., using the digital footprint data 230 of the user as described below). For example, the mapping program 110 may solicit the user to identify demographic information of the user and topics of interest to the user via the graphical user interface 290.

Additionally, the mapping program 110 may identify topics of interest to the user by developing a psychometric profile of the user (for example, by asking the user to make a series of pairwise comparisons). If a set of users of the mapping program 110 have identified topics of interest and the mapping program 110 has developed psychometric profiles of those users, the mapping program 110 may compare the psychometric profile of the user to the psychometric profiles of the users and infer that the user has similar topics of interest as other users with similar psychometric profiles, demographics, locations of interest, other topics of interest, etc.

Additionally, the mapping program 110 may use the digital footprint data 230 of the user to infer topics of interest to that user. The analysis of the digital footprint data 230 may also be used to generate the psychometric profile of the user, which may then be used to identify users with similar psychometric profiles, demographics, and/or other user profile data 220 as described above. The digital footprint data 230 of the user may be received by the server computer 102 from third-party sources (not shown) via the network 108. The digital footprint data 230 and/or the analysis of the digital footprint data 230 may be stored (temporarily or permanently) by the server computer 102 in any non-transitory computer-readable storage medium (for example, the database 112).

The digital footprint data 230 of the user may include any data created by the user while using the internet. For example, the digital footprint data 230 of the user may include the user's internet search history, social media posts and photographs, location data identifying the location of a mobile device of the user, etc. The mapping program 110 may analyze the social media posts of the user (for example, using natural language processing) to identify locations and topics of interest of the user.

The mapping program 110 may analyze photographs in the digital footprint data 230 of the user (e.g., photographs taken by or shared by the user) to identify locations and topics of interest to the user. For example, the mapping program 110 may identify the location of the photograph by reading the metadata included in the photograph. In those instances, the mapping program 110 may infer the geographic coordinates of the photograph (i.e., the country, the city, etc.) and potential topics of interest in the immediate vicinity of those coordinates (e.g., specific buildings, festivals that occurred at that location during that time, etc.). In another example, the mapping program 110 may analyze the content of those photographs (e.g., using object recognition algorithms) to identify the subject matter of the photographs (e.g., the topology and flora of landscape photographs, specific historical objects, specific buildings, architectural styles, etc.) and infer that the user has an interest in that identified subject matter.

The GIS map data 240 includes maps, in the GIS format, that each depict the geographic distribution of information. The information depicted in each map is relevant to one or more topics. For example, each map in the GIS map data 240 may include one or more keywords identifying the relevant topics of the information depicted in the map. In most instances, the information depicted in each map will be relevant to a specific date or time period identified in the GIS map data 240. The user profile data 220 and the GIS map data 240 may be stored by the server computer 102 in any non-transitory computer-readable storage medium (for example, the database 112).

The graphical user interface 290 may be any interface that receives instructions from users of the mapping program 110 (via user device 104) and displays information to users of the mapping program 110 (via the user device 104). The graphical user interface 290 may be realized as software instructions (e.g., a web application) stored and executed by the server computer 102 and available to the user device 104 (e.g., via a web browser). Additionally or alternatively, the graphical user interface 290 may be realized as software instructions (e.g., a software application or mobile application) downloaded to and stored and executed by the user device 104 in communication with the server computer 102 (e.g., via an application server or mobile application server).

The third-party geographic data 270 may include any information relevant to the locations depicted in the maps included in the GIS map data 240, the topics relevant to the information depicted in the maps included in the GIS map data 240, and the dates or time periods included in the GIS map data 240. In most instances, the third-party geographic data 270 will include a relevant geographic location, topic, and time period. The third-party geographic data 270 may be received by the server computer 102 from third-party sources (not shown) via the network 108. For example, the map program 110 may obtain the third-party geographic data 270 from publicly available sources via the internet (e.g., using web scraping programs). Additionally or alternatively, the map program 110 may be configured to receive third-party geographic data 270 from proprietary databases of information relevant to locations, topics, and/or time periods. The third-party geographic data 270 may be any combination of structured data and/or natural language descriptions. The map program 110 may identify the relevant locations, geographic locations, topics, and time periods by analyzing the received information (e.g., by using natural language processing and/or software that recognizes structured data sets).

As described in detail below, the mapping program 110 generates the component maps 250 and the composite maps 260 based on the user profile data 220, instructions (and, in some instances, additional preference information) received from the user via the graphical user interface 290, and the GIS map data 240. The mapping program 110 also generates thematic threads 280, which are graphical user interface views enabling the user to view third-party geographic data 270 regarding locations of interest. The mapping program 110 generates those thematic threads 280 based on the composite maps 260, instructions (and, in some instances, additional preference information) received from the user via the graphical user interface 290, and the third-party geographic data 270. The component maps 250, the composite maps 260 and the thematic threads 280 may be stored by the server computer 102 in any non-transitory computer-readable storage medium (for example, the database 112).

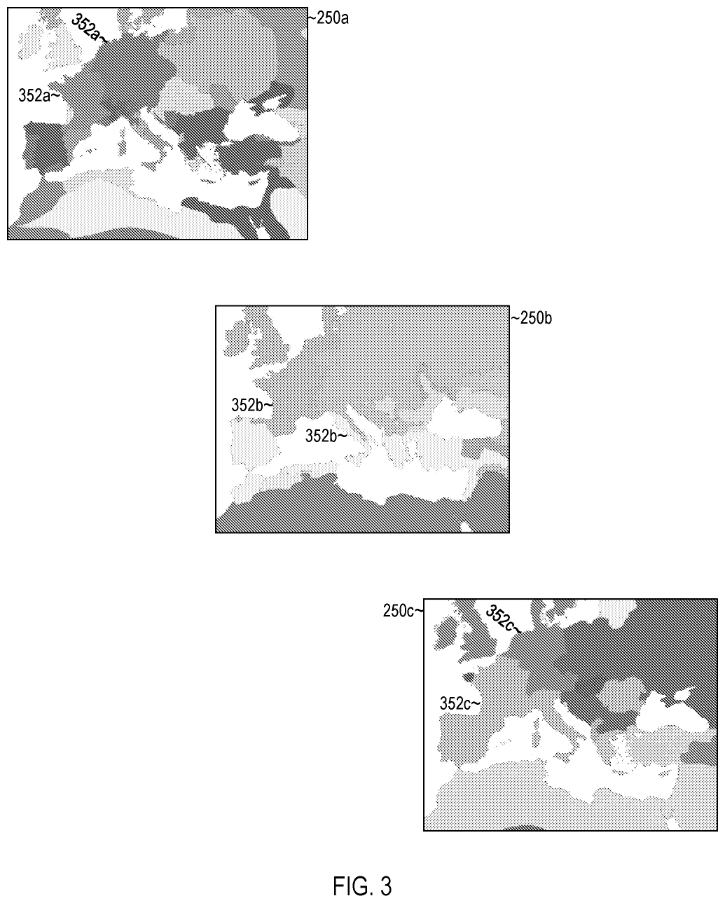

FIG. 3 illustrates component maps 250 according to an exemplary embodiment.

In the example depicted in FIG. 3, three component maps 250a, 250b, and 250c are identified by the mapping program 110 as depicting the geographic distribution of information relevant to one of the topics of interest to the user. Each component map 250 is a GIS overlay layer that superimposes data from a data set relevant to a topic of interest to the user. For example, the component map 250a may depict the primary language spoken is each component geographic region 352a, the component map 250b may depict the climate is each component geographic region 352b, and the component map 250c may depict the boundaries of empires during an identified year (e.g., 1453 A.D.) by displaying component geographic regions 352c.

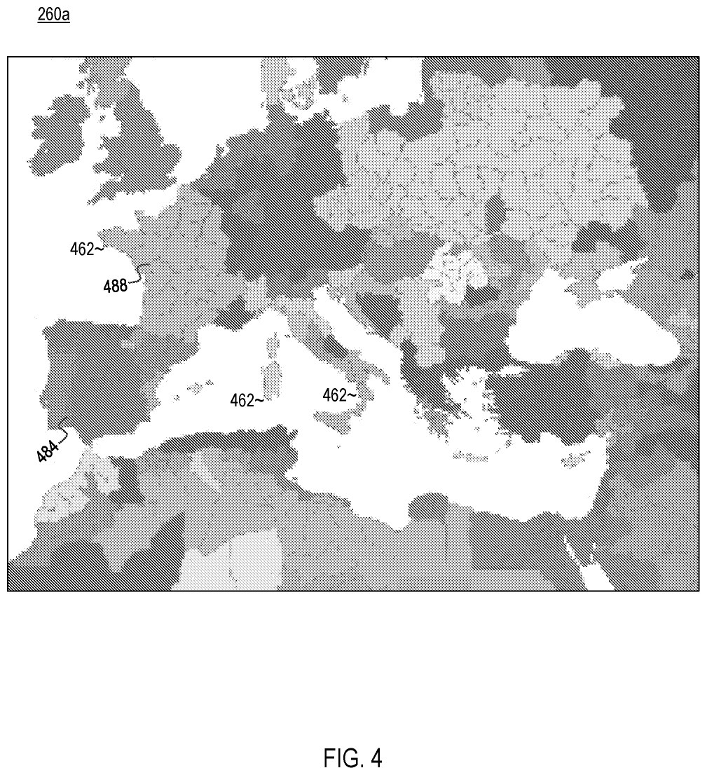

FIG. 4 illustrates an example composite map 260a according to an exemplary embodiment.

Composite maps 260 are GIS overlays that superimpose data from the component maps 250 identified by the mapping program 110 and selected by the user. The mapping program 110 generates composite maps 260 by combining each of the component maps 250 (identified by the mapping program 110 and selected by the user) and identifying each composite geographic region 462 having a distinct combination of the relevant topics of interest in the component geographic regions 352 in the selected component maps 250. In other words, using the example component geographic regions 352a, 352b, and 352c, the mapping program 110 identifies the composite geographic regions 462 having a specific primary language (as identified in a component geographic region 352a of component map 250a) and a specific climate (as identified in a component geographic region 352b of component map 250b), and a specific empire in the year 1453 A.D. (as identified in a component geographic region 352c of component map 250b).

When generating the component maps 250, the mapping program 110 may identify geographic regions 352 that are distinct from any current national boundary or current subnational boundary. However, when generating the composite maps 260, the mapping program 110 may include an overlay of national boundaries 484 and subnational boundaries 488. The subnational boundaries 488, for example, may be subnational boundaries recognized by the International Organization for Standardization (ISO).

In order provide the user with a better sense of where each composite geographic region 462 intersects with the present-day geographic boundaries already familiar to users, the mapping program 110 may adjust the boundaries of the composite geographic regions 462 to conform to (i.e., “snap to”) the nearest subnational boundary 488. Therefore, each composite geographic region 462 may be adjusted (e.g., averaged, enlarged, contracted, or shifted) such that the composite geographic region 462 conforms to recognized, present day subnational boundaries 488.

As illustrated in FIG. 4, the mapping program 110 provides functionality for a user to “remap the world” and examine regional variations in the topics of interest to the user (stored in the user profile data 220 and/or specified via the graphical user interface 290). Additionally, as described below, the mapping program 110 provides functionality to identify specific places with specific attributes identified by the user.

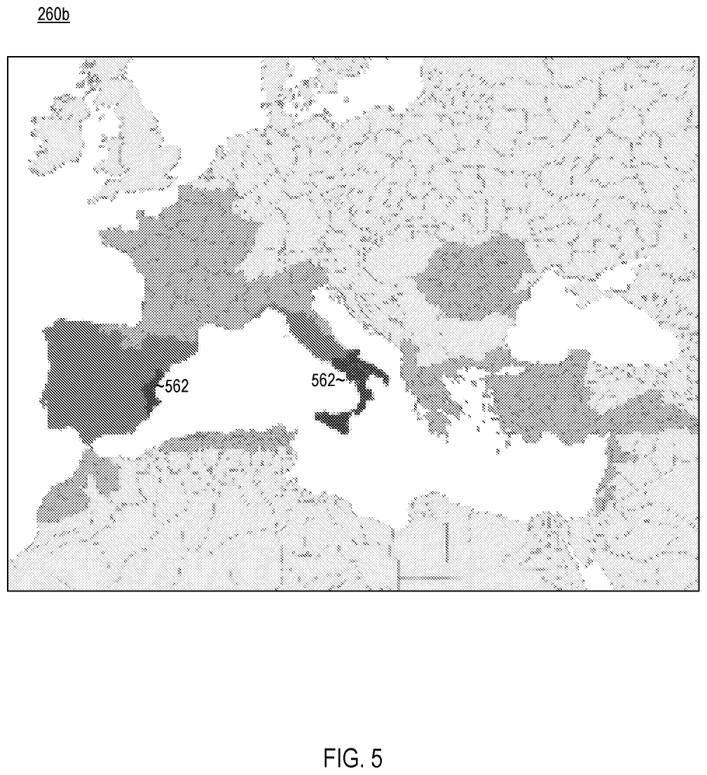

FIG. 5 illustrates another example composite map 260b according to an exemplary embodiment.

As described above, the mapping program 110 generates composite maps 260 by combining each of the component maps 250 (identified by the mapping program 110 and selected by the user) and identifying each composite geographic region 462 having a distinct combination of the relevant topics of interest in the component geographic regions 352 in the selected component maps 250. However, in addition to identifying all of the composite geographic regions 462 with distinct attributes for each of the topics of interest as shown in FIG. 4, the mapping program 110 may also identify geographic regions of interest 562 having specific attributes identified by the user (as stored in the user profile data 220 and/or specified via the graphical user interface 290).

For example, the composite map 260b may be a heatmap showing the prevalence of specific attributes specified by the user. In the example shown in FIG. 5, the mapping program 110 identified geographic regions of interest 562 for a user that specified a desire to identify locations that are exemplars of early modern Mediterranean history, where romance languages are widely spoken, and which are likely to be warm and dry in the preferred Autumn travel time. Again, the geographic regions of interest 562 may be identified irrespective of the present-day national boundaries 484 or subnational boundaries 488. Alternatively, the mapping program 110 may adjust each boundary of the geographic regions of interest 562 to conform to the nearest subnational boundary 488.

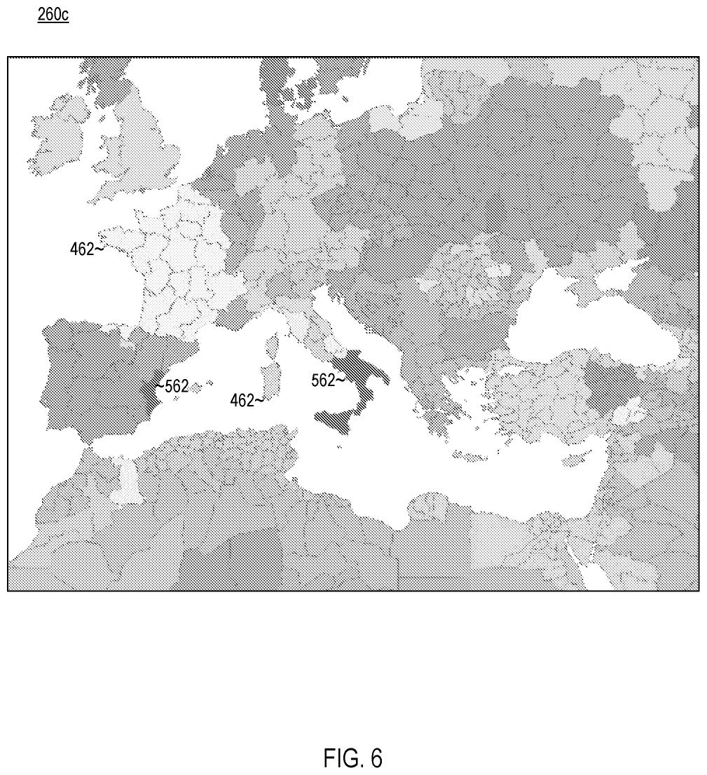

FIG. 6 illustrates another example composite map 260c according to an exemplary embodiment.

As described above, the mapping program 110 identifies each composite geographic region 462 having a distinct combination of the relevant topics of interest in the component geographic regions 352 in the selected component maps 250. Additionally, the mapping program 110 may also identify geographic regions of interest 562 having specific attributes identified by the user (as stored in the user profile data 220 and/or specified via the graphical user interface 290).

Accordingly, as shown in FIG. 6, the mapping program 110 may generate a composite map 260c that includes both the composite geographic regions 462 and geographic regions of interest to the user 562.

Because the mapping program 110 provides functionality to identify geographic regions of interest 562 with specific attributes identified by the user, the mapping program 110 may be used by individuals interested in travel, education, and organizations performing business intelligence functions. The composite maps 260 output by the mapping program 110 via the graphical user interface 290 also provide functionality for a user to select one of the composite geographic regions 462 or geographic regions of interest 562. Then, as described below, the mapping program 110 provides functionality for the user to learn more about the selected composite geographic regions 462 or geographic regions of interest 562 using what are referred to as “thematic threads” 280.

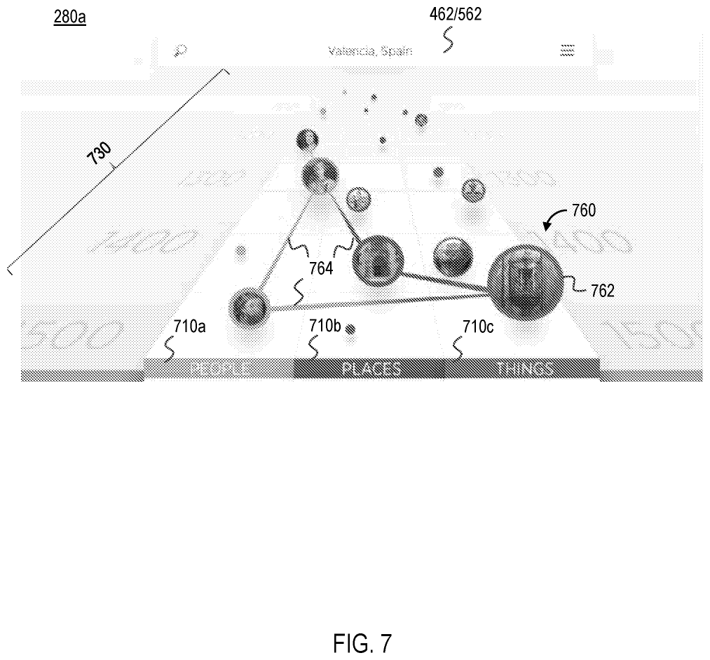

FIGS. 7-9 illustrates example thematic threads 280 output via the graphical user interface 290 according to exemplary embodiments.

As described above, the mapping program 110 identifies third-party geographic data 270 relevant to the locations depicted in the maps included in the GIS map data 240, including the composite locations 462 included in the composite maps 460 and the locations of interest to the user 562. Accordingly, as shown in FIG. 7, the thematic thread 280a provides a user interface that allows a user to explore the third-party geographic data 270 relevant to a location of interest to the user 562 (in this example, Valencia, Spain) or any composite location 462 selected by the user.

The third-party geographic data 270 may include information licensed from proprietary information sources (e.g., a database from an online travel information provider, an online encyclopedia, etc.). As such, the third-party geographic data 270 may be a structured data set that includes information relevant to a geographic location, topic, and, in most instances, a time period. Additionally, the third-party geographic data 270 may be unstructured information scraped from publicly available sources (e.g., Wikipedia, travel blogs, etc.). The mapping program 110 may use natural language processing and other algorithms to organize the unstructured information and add that unstructured information to the structured third-party geographic data 270. The mapping program 110 may use artificial intelligence (e.g., a machine learning process) to structure the scraped unstructured information. For example, some of the scraped information may be organized into a training set of the structured third-party geographic data 270 (e.g., by hand or by a machine learning process supervised by humans) and the machine learning algorithm trained on the training set may develop heuristics or rules to further organize the remainder of the scraped, unstructured third-party geographic data 270.

In most instances, the third-party geographic data 270 will include a relevant geographic location, topic, and time period. Accordingly, each thematic thread 280a may be realized as a timeline with time periods 730 along one axis and topics 710 (e.g., people 710a, places 710b, and things 710c) along another axis. The mapping program 110 may organize the third-party geographic data 270 into a hierarchical taxonomy that includes each topics 710, subtopics within those topics 710, items belonging to those topics 710 and subtopics, and relationships between those items. Along each thematic thread 280a, icons 762 representing items 760 relevant to that topic 710 during that time period 730 and, in some embodiments, relationships 764 between those items 760.

Because the third-party geographic data 270 is organized in a hierarchical taxonomy, the mapping program 110 may provide functionality for users to explore increasingly granular topics 710. For example, selecting things 710c may cause the graphical user interface 290 to present a thematic thread 280 of subtopics (e.g., buildings, landscapes, monuments) relevant to the selected location 462 or 562. Meanwhile, selecting buildings, may cause the graphical user interface 290 to present a thematic thread 280 of even more granular subtopics relevant to the selected location 462 or 562 (e.g., architectural styles, houses of worship, historically relevant buildings).

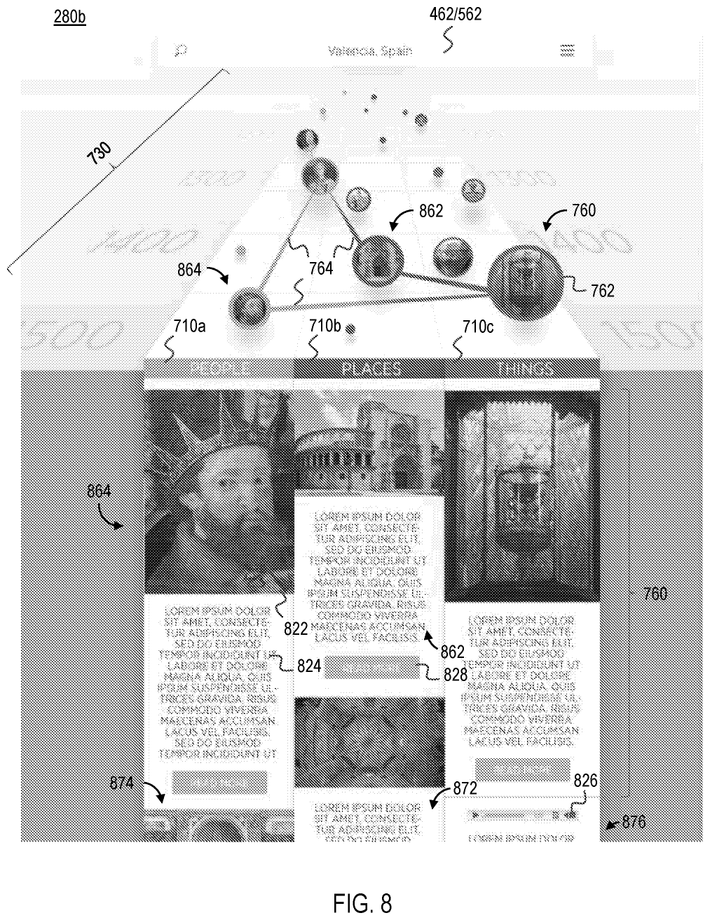

Those icons 762 may be selected to view information in the third-party geographic data 270 (or excerpts from that third-party geographic data 270) regarding the selected item 760. As shown in FIG. 8, for example, selecting an icon 762 representing an item 760 may cause the mapping program 110 to generate a thematic thread 280b with third-party geographic data 270 regarding the selected item 760 and other items 862 and 864 related to the selected item 760. The thematic thread 280b may include images 822, text 824, audio files 826, data tables, graphics, and/or links 828 to see or read more either at the third-party source or within the mapping system 200. The related items 862 and 864 may be in other topics 710. For example, a religious relic 760 may have been brought to a place 862 by a person 864. Within each topic 710, additional items 872, 874, and 866 of increasing granularity may be presented. For example, places 710b may include the ceiling 872 of the chapel 862 that currently displays the relic 760. Selecting items 760 of interest and related items 760 also provides functionality for the user to explore items 760 in geographic locations 462 that may not have been initially selected by the user when viewing the composite maps 260.

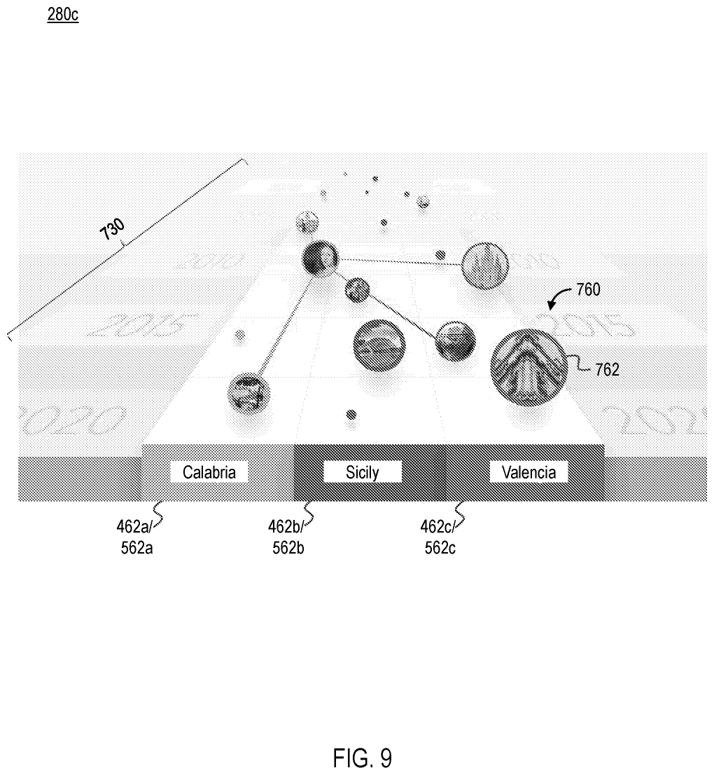

The mapping program 110 also provides functionality to view third-party geographic data 270 relevant to multiple locations of interest to the user 562 (or multiple composite locations 462 selected by the user). Accordingly, as shown in FIG. 9, the thematic thread 280c may be realized as a timeline with time periods 730 along one axis and locations of interest to the user 562 (or multiple composite locations 462 selected by the user) along another axis. Along each thematic thread 280c, icons 762 may represent items 760 in third-party geographic data 270 relevant to that location 462 or 562 during that time period 730. Those icons 762 may be selected to view the third-party geographic data 270 relevant to that location 462 or 562 during that time period 730, either at the third-party source or within the mapping system 200.

Ultimately, the mapping program 110 provides functionality for users to identify locations of interest 562 and items 760 of interest. However, the mapping program 110 may determine which items 760 to initially include in the thematic threads 280 based on their relative importance or a determination of which items 760 may be of interest to the specific user based on the user profile data 220. The relative importance of an initial set of items 760 may be made by humans making subjective determinations. However, going forward, determinations regarding the importance of each item 760 may be made by a recursive algorithm (e.g., an artificial intelligence or machine learning process) that identifies items 760 that were of interest to other users (or other users with similar locations of interest 562, user profile data 220, demographic information, psychometric profiles, etc.). Users may even be ranked based on whether their items 760 of interest were of interest to other users, with user selection being given more weight if that user is higher ranked.

The graphical user interface 290 may render the thematic threads 280 to a two-dimensional display device. In other embodiments, the graphical user interface 290 may render the thematic threads 280 as an immersive, three-dimensional experience (e.g., via a head-mounted stereoscopic display or a display that provides augmented reality images).

As described above, the composite maps 260 and thematic threads 280 provide functionality for the user to identify and select geographic locations 462 or 562 and items 760 of interest to the user. The graphical user interface 290 may even provide functionality for a user to rate or rank each geographic location 462 or 562 or item 760 based on the relative interest of the user. Meanwhile, as described below, the mapping program 110 may further provide functionality for the user to plan a trip to those geographic locations 462 or 562 and to see those item 760. Therefore, in addition to educational and corporate intelligence uses, thematic threads 280 can be used by individuals to plan and organize vacation travel. Additionally, the graphical user interface 290 may provide functionality for users to upload and store their own information (e.g., notes and photographs taken during vacation travel) and organize that uploaded information into a thematic thread 280.

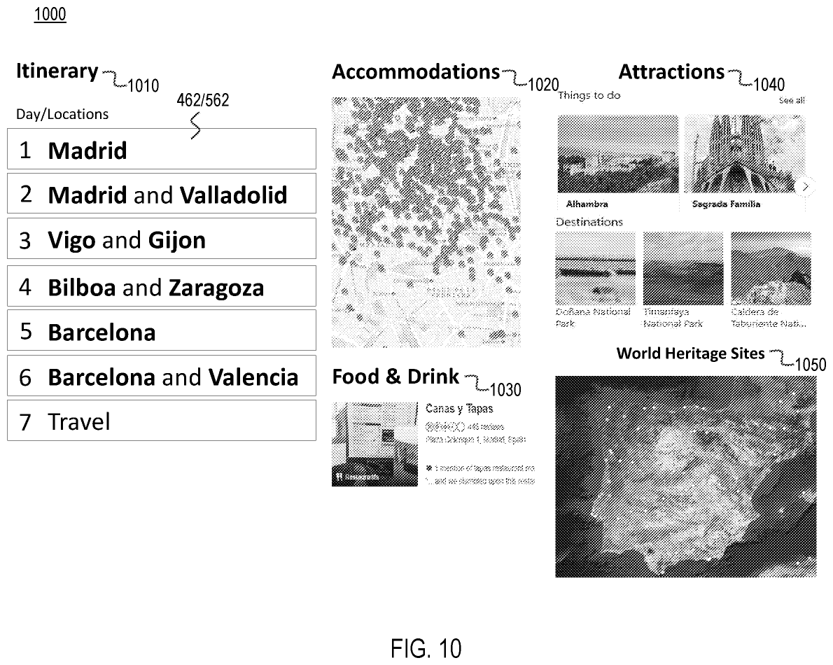

FIG. 10 illustrates an itinerary view 1000 output by the graphical user interface 290 according to an exemplary embodiment.

As shown in FIG. 10, the itinerary view 1000 may include an itinerary 1010 listing locations of interest to the user 582, composite geographic regions 462 selected by the user, or geographic regions 462 that include items 760 of interest to the user. The graphical user interface 290 may provide functionality for users to specify a time frame and/or a budget. The mapping program 110 may be configured to generate the itinerary 1010 to conform to the user's budget and available leisure time, minimize travel time between the geographic regions 462 or locations of interest 582 (e.g., using a travel optimization algorithm), to avoid times when attractions are closed or crowded (e.g., as identified by third-party geographic data 270), etc. The mapping program 110 may provide functionality to adjust the itinerary 1010, for example functionality to specify dates and/or add, remove, or extend the user's stay at any of the geographic regions 462 or locations of interest 582. In response to the user input, the mapping program 110 may be configured to generate a new itinerary 1010 that minimizes travel time, avoid closures and crowds, etc.

The itinerary view 1000 may also include accommodations 1020, restaurants 1030, attractions 1040, and additional locations of interest 1050 (e.g., UNESCO World Heritage Sites), etc. The accommodations 1020, restaurants 1030, attractions 1040, and additional locations of interest 1050 may be included in the third-party geographic data 270.

The mapping system 200 may provide functionality to book travel to the geographic regions 462 or locations of interest 582, book accommodations 1020, make reservations at the restaurants 1030, purchase tickets to the attractions 1040, etc.

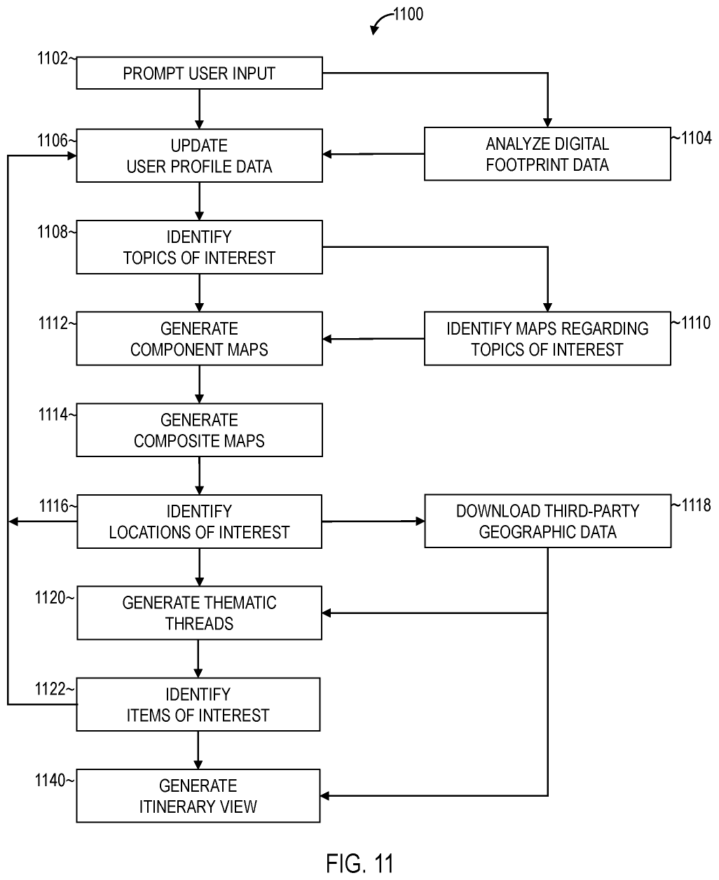

FIG. 11 is a flowchart of a process 1100 for generating the component maps 250, composite maps 260, thematic threads 280, and/or itinerary views 1000 according to an exemplary embodiment.

The mapping program 110 prompts the user for user input in step 1102. The mapping program 110 may prompt the user to identify topics or locations of interest, answer questions used to develop of psychometric profile, identify social media accounts, etc.

In some embodiments the mapping program 110 analyzes the digital footprint data 230 (of the accounts identified by the user in step 1102) in step 1104.

The user profile data 220 of the user is updated (based on the user input received in step 1102, the digital footprint data 230 analyzed in step 1104, etc.) in step 1106.

The mapping program 110 identifies topics of interest to the user in step 1108.

The mapping program 110 identifies maps in the GIS map data 240 that are relevant to the topics of interest to the user in step 1110.

Using the GIS map data 240 identified in step 1110, the mapping program 110 generates component maps 250 in step 1112.

Using the component maps 250 generated in step 1112, the mapping program 110 generates composite maps 260 in step 1114. As described above, the composite maps 260 may be include composite geographic regions 462 that are selectable by the user and/or specific locations of interest to the user 582.

The mapping program 110 identifies locations of interest to the user in step 1116. As described above, the locations of interest to the user may be identified using specific user profile data 220 (or information input by the user via the graphical user interface 290) and/or by providing functionality for a user to select a geographic region 462 in a composite map 460. After identifying the composite geographic regions 462 selected by the user and/or specific locations of interest to the user 562, the mapping program 110 updates the user profile data 220 to incorporate that user preference information.

The mapping program 110 downloads third-party geographic data 270 regarding the composite geographic regions 462 selected by the user and/or specific locations of interest to the user 562 in step 1118.

Using the third-party geographic data 270 downloaded in step 1118, the mapping program 110 generates thematic thread 280 for the composite geographic regions 462 selected by the user and/or specific locations of interest to the user 582 in step 1120.

The mapping program 110 provides functionality for the user to identify items 760 of interest in step 1122. The mapping program 110 updates the user profile data 220 to incorporate that user preference information.

Using the third-party geographic data 270 downloaded in step 1118, the mapping program 110 may generate an itinerary view 1100 for the composite geographic regions 462 selected by the user and/or specific locations of interest to the user 582 in step 1140.

FIG. 12 depicts a block diagram of a computing system 1200 within the mapping environment 100 of FIG. 1 according to an exemplary embodiment. It should be appreciated that FIG. 12 provides only an illustration of one implementation and does not imply any limitations with regard to the environments in which different embodiments can be implemented. Many modifications to the depicted environment can be made.

As shown in FIG. 12, the computer system 1200 includes communications fabric 1202, which provides communications between a cache 1216, memory 1206, persistent storage 1208, a communications unit 1210, and one or more input/output (I/O) interfaces 1212. The communications fabric 1202 may be implemented with any architecture designed for passing data and/or control information between processors (such as microprocessors, communications and network processors, etc.), system memory, peripheral devices, and any other hardware components within a system. For example, communications fabric 1202 can be implemented with one or more buses or a crossbar switch.

The memory 1206 and the persistent storage 1208 are non-transitory computer readable storage media. In this embodiment, the memory 1206 includes random access memory (RAM). In general, the memory 1206 may include any suitable volatile or non-volatile computer readable storage media. The cache 1216 is a fast memory that enhances the performance of computer processor(s) 1204 by holding recently accessed data, and data near accessed data, from memory 1206.

The map program 110 may be stored in the persistent storage 1208 and in memory 1206 for execution by one or more of the respective computer processors 1204 via the cache 1216. In an embodiment, the persistent storage 1208 includes a magnetic hard disk drive. Alternatively, or in addition to a magnetic hard disk drive, the persistent storage 1208 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 1208 may also be removable. For example, a removable hard drive may be used for the persistent storage 1208. Other examples include optical and magnetic disks, thumb drives, and smart cards that are inserted into a drive for transfer onto another computer readable storage medium that is also part of the persistent storage 1208.

The communications unit 1210, in these examples, provides for communications with other data processing systems or devices. In these examples, the communications unit 1210 includes one or more network interface cards. The communications unit 1210 may provide communications through the use of either or both physical and wireless communications links. The map program 110 may be downloaded to the persistent storage 1208 through the communications unit 1210.

The I/O interface(s) 1212 allows for input and output of data with other devices that may be connected to server computer 102 and user device 104. For example, the I/O interface 1212 may provide a connection to external devices 1218 such as a keyboard, keypad, a touch screen, a microphone and/or some other suitable input device. The external devices 1218 may also include portable computer readable storage media such as, for example, thumb drives, portable optical or magnetic disks, and memory cards. Software and data used to practice embodiments of the present invention, e.g., the map program 110, may be stored on such portable computer readable storage media and can be loaded onto persistent storage 1208 via the I/O interface(s) 1212. The I/O interface(s) 1212 also connect to a display 1220.

The display 1220 provides a mechanism to display data to a user and may be, for example, a computer monitor.

The foregoing description and drawings should be considered as illustrative only of the principles of the disclosure, which may be configured in a variety of shapes and sizes and is not intended to be limited by the embodiment herein described. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

1. A mapping and travel planning system comprising:
non-transitory computer readable storage media (CRSM) that stores:
user profile data;
geographic information system (GIS) map data that includes maps, each map being associated with a topic and dividing a geographic area based on one or more attributes relevant to the topic; and
geographic data that includes attractions in geographic locations, items relevant to geographic locations, and information regarding the items relevant to geographic locations;
a hardware computer processor configured to:
identify, based on the user provide data, a plurality of topics of interest to the user and, for each of the topics of interest to the user, one or more attributes of interest to the user;
for each of the topics of interest to the user, identify a component map in the GIS map data dividing a geographic area into component geographic regions having an attribute relevant to the topic of interest to the user;
combine the identified component maps to generate a composite map dividing a geographic area into composite geographic regions, each composite geographic region having one attribute relevant to each of the identified topics of interest to the user;
output, to the user, the composite map and the prevalence of the attributes of interest to the user in each of the composite geographic regions;
provide functionality for the user to select one or more geographic locations of interest to the user;
identify, from the geographic data for the user, attractions in the one or more geographic locations of interest to the user;
select, from the geographic data, items relevant to the one or more geographic locations of interest to the user based on the topic of interest to the user;
output, to the user, the selected items and information regarding the selected items;
provide functionality for the user to select one or more items of interest to the user; and
generate a proposed itinerary for the user to travel to the one or more items of interest to the user and/or the attractions in the one or more geographic locations of interest to the user.

2.-20. (canceled)

21. The mapping and travel planning system of claim 1, wherein the hardware computer processor is configured to identify the topics of interest to the user and/or the attributes of interest to the user by:
providing functionality for the user to identify demographic information of the user; and
developing a psychometric profile of the user by asking the user to make a series of pairwise comparisons regarding the relative importance of potential topics of interest and/or potential attributes of interest.

22. The mapping and travel planning system of claim 21, wherein the hardware computer processor is configured to identify the topics of interest to the user and/or the attributes of interest to the user by:
identifying one or more users having similar demographic information and/or psychometric profiles; and
identifying the topics of interest and/or the attributes of interest to the users having similar demographic information and/or psychometric profiles.

23. The mapping and travel planning system of claim 1, wherein the hardware computer processor is configured to identify the topics of interest to the user and/or the attributes of interest to the user by analyzing digital footprint data that includes an internet search history of the user, location data identifying locations of a mobile device of the user, or social media posts or photographs shared by the user.

24. The mapping and travel planning system of claim 23, wherein the hardware computer processor is configured to identify the topics of interest to the user and/or the attributes of interest to the user by using object recognition algorithms to identify the content of photographs shared by the user or reading metadata included in the photographs to identify the location of the photographs shared by the user.

25. The mapping and travel planning system of claim 1, wherein the hardware computer processor is further configured to adjust the boundaries of each composite geographic region to conform to subnational boundaries.

26. The mapping and travel planning system of claim 1, wherein:
the geographic data is a structured data set; and
the hardware computer processor is configured to:
scrape unstructured information from publicly available sources; and
use natural language processing to organize the unstructured information and add the unstructured information to the structured data set.

27. The mapping and travel planning system of claim 1, wherein:
the geographic data is organized in a hierarchical taxonomy that includes topics related to the items, subtopics related to each of the topics, and relationships between the items; and
the hardware computer processor is configured to:
identify subtopics related to topics selected by the user and items related to the identified subtopics; and
items related to the one or more items of interest to the user.

28. The mapping and travel planning system of claim 1, wherein the items include people, places, things, landscapes, monuments, buildings, architectural styles, houses of worship, or historically relevant buildings.

29. The mapping and travel planning system of claim 1, wherein the hardware computer processor is configured to identify items for the user based on the user profile of the user.

30. The mapping and travel planning system of claim 1, wherein:
the hardware computer processor provides functionality for users to upload information regarding geographic locations and/or items relevant to geographic locations;
the geographic data includes information uploaded by users.

31. The mapping and travel planning system of claim 1, wherein:
the geographic data further includes accommodations or restaurants in geographic locations; and
the proposed itinerary further includes functionality to book accommodations or make reservations at restaurants in the one or more geographic locations of interest to the user.

32. The mapping and travel planning system of claim 1, wherein the hardware computer processor provides functionality for the user to specify a time frame or budget and generates the proposed itinerary to conform to the time frame or budget specified by the user.

33. The mapping and travel planning system of claim 1, wherein the hardware computer processor generates the proposed itinerary using a travel optimization algorithm to minimize travel time.

34. The mapping and travel planning system of claim 1, wherein:
the geographic data includes times when attractions are closed or crowded; and
the hardware computer processor generates the proposed itinerary to avoid times when attractions are closed or crowded.
